(19) United States
(12) Patent Application Publication
(10) Pub. No.: US 2021/0241644 A1
(43) Pub. Date: Aug. 5, 2021

(54) APPARATUS, METHOD AND RECORDING MEDIUM STORING COMMAND FOR SUPPORTING LEARNING

(71) Applicant: ST Unitas Co., Ltd., Seoul (KR)

(72) Inventors: Sung Hyuk Yoon, Seoul (KR); Bon Jun Koo, Seoul (KR); Joo Young Yoon, Seoul (KR); Hwe Chul Cho, Hoboken, NJ (US); Se Won Cho, Long Island City, NY (US)

(73) Assignee: ST Unitas Co., Ltd., Seoul (KR)

(21) Appl. No.: 16/780,086

(22) Filed: Feb. 3, 2020

(51) Int. Cl. G09B 7/04; G06K 9/62; G06K 9/00; G06N 3/08

(52) U.S. Cl. CPC G09B 7/04; G06K 9/6215; G06K 2209/01; G06N 3/08; G06K 9/00456

(57) ABSTRACT

An apparatus for supporting learning of a user is provided. The apparatus extracts, from a problem image, a first layout including textual information and a second layout including illustrative information, determines a first similarity between the first layout and textual information of a second problem stored, determines a second similarity between the second layout and illustrative information of the second problem, determines a third similarity between the first problem and the second problem by combining the first similarity and the second similarity, determines whether the second problem corresponds to the first problem, and transmits information indicating an answer or solution corresponding to the second problem to the user device.

### TECHNICAL FIELD

The present disclosure relates to a technology for supporting learning of a user.

### BACKGROUND

To support learning of a user (e.g., a student), various methods can be applied using information and communications technology. For example, an online service for connecting users may be provided for private tutoring. Also, to help a user with his or her homework, a service for providing information related to the homework may be provided. As such, various methods can be used to support learning of users in many ways. However, when a user wants an answer and/or solution to a specific problem, supporting the user in a more immediate and simple way is required.

To meet such requirement, it is possible to perform optical character recognition (OCR) on the text of a photograph of a problem, compare the problem with problems in a database, and provide a solution to the problem. However, this method may be problematic because mathematical expressions in text, particularly, mathematical symbols, may not be recognized properly, a character recognition rate varies according to the font of text, the recognized text in a graph (such as coordinate values) of a problem may not be helpful in searching a database for a corresponding problem even when recognized with OCR, and illustrative elements of a problem (such as a graph and a drawing) may not be fully reflected in a search for a problem.

### SUMMARY

Various embodiments of the present disclosure provide a technology for supporting learning of a user.

An apparatus for supporting learning of a user based on one embodiment of the present disclosure may include: a transceiver configured to receive a problem image of a first problem from an user device; one or more processors; and one or more memories configured to store commands that cause the one or more processors to perform an operation when the commands are executed by the one or more processors, and information related to a plurality of problems, wherein the one or more processors are configured to: extract, from the problem image, a first layout including an area of the problem image in which textual information of the first problem is located and a second layout including an area of the problem image in which illustrative information of the first problem is located; determine a first similarity between the first layout and textual information of a second problem stored in the one or more memories; determine a second similarity between the second layout and illustrative information of the second problem; determine a third similarity between the first problem and the second problem by combining the first similarity and the second similarity; determine whether the second problem corresponds to the first problem based on whether the third similarity is larger than or equal to a predetermined reference similarity; and upon determining that the second problem corresponds to the first problem, control the transceiver to transmit information indicating an answer or solution corresponding to the second problem to the user device.

The one or more processors may input the first layout to a first neural network model that is trained to derive a first vector representation from an image having textual information; obtain the first vector representation of the first layout from the first neural network model; and determine the first similarity by comparing the first vector representation of the first layout with a previously stored vector representation of the textual information of the second problem.

The one or more processors may pre-process the first layout by replacing a proper noun or a constant of the textual information of the first layout with a placeholder, before inputting the first layout to the first neural network model.

The one or more processors may input the second layout to a second neural network model that is trained to derive a second vector representation from an image having illustrative information; obtain the second vector representation of the second layout from the second neural network model; and determine the second similarity by comparing the second vector representation of the second layout with a previously stored vector representation of the illustrative information of the second problem.

The one or more processors may determine a first combination factor to be applied to the first similarity and a second combination factor to be applied to the second similarity based on predetermined criteria; and determine the third similarity by combining the first similarity to which the first combination factor is applied and the second similarity to which the second combination factor is applied.

The predetermined criteria may be that: as an amount of the textual information of the first layout compared to a size of the first layout decreases, the first combination factor decreases, as the number of problems having a certain similarity or more with the first layout stored in the one or more memories decreases, the first combination factor decreases, as an amount of the illustrative information of the second layout compared to a size of the second layout decreases, the second combination factor decreases, and as the number of problems having a certain similarity or more with the second layout stored in the one or more memories decreases, the second combination factor decreases.

The one or more processors may extract, from the problem image, an area of the problem image in which each piece of information of the first problem is located as one or more layouts; and determine each of the one or more layouts as the first layout or the second layout by inputting the one or more layouts to a third neural network model that is trained to distinguish between textual information and illustrative information.

At least one of the first neural network model, the second neural network model, and the third neural network model is stored in a server, and wherein the one or more processors control the transceiver to communicate with the server.

The one or more processors may store the problem image of the first problem in the one or more memories upon determining that no problem corresponds to the first problem among the plurality of problems.

The textual information of the first problem may include text or a mathematical expression of the first problem, and wherein the illustrative information of the first problem includes a drawing, a picture, a table, or a graph of the first problem.

A method of supporting learning of a user based on another embodiment of the present disclosure may be performed by an apparatus including a transceiver communicating with a user device, one or more processors, and one or more memories storing commands that cause the one or more processors to perform an operation when the commands are executed by the one or more processors, and information related to a plurality of problems, the method comprising: receiving, by the transceiver, a problem image of a first problem from the user device; extracting, from the problem image by the one or more processors, a first layout including an area of the problem image in which textual information of the first problem is located and a second layout including an area of the problem image in which illustrative information of the first problem is located; determining, by the one or more processors, a first similarity between the first layout and textual information of a second problem stored in the one or more memories; determining, by the one or more processors, a second similarity between the second layout and illustrative information of the second problem; determining, by the one or more processors, a third similarity between the first problem and the second problem by combining the first similarity and the second similarity; determining, by the one or more processors, whether the second problem corresponds to the first problem based on whether the third similarity is larger than or equal to a predetermined reference similarity; and upon determining that the second problem corresponds to the first problem, transmitting, by the transceiver, information indicating an answer or solution corresponding to the second problem to the user device.

The determining of the first similarity may include: inputting the first layout to a first neural network model that is trained to derive a first vector representation from an image having textual information; obtaining the first vector representation of the first layout from the first neural network model; and determining the first similarity by comparing the first vector representation of the first layout with a previously stored vector representation of the textual information of the second problem.

The determining of the first similarity may include, pre-processing the first layout by replacing a proper noun or a constant of the textual information of the first layout with a placeholder, before inputting the first layout to the first neural network model.

The determining of the second similarity may include: inputting the second layout to a second neural network model that is trained to derive a second vector representation from an image having illustrative information; obtaining the second vector representation of the second layout from the second neural network model; and determining the second similarity by comparing the second vector representation of the second layout with a previously stored vector representation of the illustrative information of the second problem.

The determining of the third similarity may include: determining a first combination factor to be applied to the first similarity and a second combination factor to be applied to the second similarity based on predetermined criteria; and determining the third similarity by combining the first similarity to which the first combination factor is applied and the second similarity to which the second combination factor is applied.

The predetermined criteria may be that: as an amount of the textual information of the first layout compared to a size of the first layout decreases, the first combination factor decreases, as the number of problems having a certain similarity or more with the first layout stored in the one or more memories decreases, the first combination factor decreases, as an amount of the illustrative information of the second layout compared to a size of the second layout decreases, the second combination factor decreases, and as the number of problems having a certain similarity or more with the second layout stored in the one or more memories decreases, the second combination factor decreases.

The extracting of the first layout and the second layout may include: extracting, from the problem image, an area of the problem image in which each piece of information of the first problem is located as one or more layouts; and determining each of the one or more layouts as the first layout or the second layout by inputting the one or more layouts to a third neural network model that is trained to distinguish between textual information and illustrative information.

The method may further include storing, by the one or more processors, the problem image of the first problem in the one or more memories upon determining that no problem corresponds to the first problem among the plurality of problems.

The textual information of the first problem may included text or a mathematical expression of the first problem, and the illustrative information of the first problem includes a drawing, a picture, a table or a graph of the first problem.

Commands for supporting learning of a user may be stored in a non-transitory computer-readable recording medium according to another embodiment of the present disclosure. The commands stored in the recording medium may be commands that cause one or more processors to perform an operation when the commands are executed by the one or more processors, the commands comprising: extracting, from a problem image of a first problem, a first layout including an area of the problem image in which textual information of the first problem is located and a second layout including an area of the problem image in which illustrative information of the first problem is located; determining a first similarity between the first layout and textual information of a second problem stored in one or more memories; determining a second similarity between the second layout and illustrative information of the second problem; determining a third similarity between the first problem and the second problem by combining the first similarity and the second similarity; determining whether the second problem corresponds to the first problem based on whether the third similarity is larger than or equal to a predetermined reference similarity; and upon determining that the second problem corresponds to the first problem, controlling a transceiver to transmit information indicating an answer or solution corresponding to the second problem to an user device.

### BRIEF DESCRIPTION OF DRAWINGS

The accompanying drawings, which are incorporated in and constitute a part of the specification, illustrate embodiments of the present disclosure.

FIG. 1 is a diagram illustrating an operation process of a learning support apparatus according to an embodiment of the present disclosure.

FIG. 2 is a block diagram of a learning support apparatus according to various embodiments of the present disclosure.

FIG. 3 is a set of diagrams illustrating a process of extracting one or more layouts from a problem image according to an embodiment of the present disclosure.

FIG. 4 is a diagram illustrating a process of determining a similarity between problems through image vectorization according to an embodiment of the present disclosure.

FIG. 5 is a diagram illustrating a process of improving a search for a problem by templatizing a target problem according to an embodiment of the present disclosure.

FIG. 6 is a diagram illustrating a process of determining a third similarity between a first problem and a second problem by using a first similarity and a second similarity according to an embodiment of the present disclosure.

FIG. 7 is a diagram illustrating a process of distinguishing between a layout having textual information and a layout having illustrative information according to an embodiment of the present disclosure.

FIG. 8 is a flowchart illustrating a method of supporting learning of a user which may be performed by a learning support apparatus according to an embodiment of the present disclosure.

### DETAILED DESCRIPTION

Various embodiments set forth herein are examples for clearly describing the present disclosure and are not intended to limit the present disclosure to specific embodiments. The scope of the present disclosure includes various modifications, equivalents, and alternatives of embodiments set forth herein and embodiments obtained by selectively combining all or some of the embodiments. Also, the scope of the present disclosure is not limited to various embodiments given below or detailed descriptions of the embodiments.

All technical or scientific terms used herein have meanings that are generally understood by a person having ordinary knowledge in the art to which the present disclosure pertains, unless otherwise specified.

The expressions “include,” “provided with,” “have,” and the like used herein denote the presence of relevant features (e.g., functions, operations, and components) and do not preclude the presence of other additional features. In other words, the expressions should be understood as open-ended terms connoting the possibility of inclusion of other embodiments, unless otherwise mentioned in a phrase or sentence including the expressions.

A singular expression can include the meaning of the plural form, unless otherwise mentioned, and the same is applied to a singular expression stated in the claims.

The terms “first,” “second,” etc. used herein are used to distinguish a plurality of components from one another, and are not intended to limit the order or importance of the relevant components.

As used herein, the expressions “A, B, and C,” “A, B, or C,” “A, B, and/or C,” “at least one of A, B, and C,” “at least one of A, B, or C,” “at least one of A, B, and/or C,” “at least one selected from among A, B, and C,” “at least one selected from among A, B, or C,” “at least one selected from among A, B, and/or C,” etc. may denote each of the listed items or all possible combinations thereof. For example, “at least one selected from among A and B” may denote (1) A, (2) at least one of A, (3) B, (4) at least one of B, (5) at least one of A and at least one of B, (6) B and at least one of A, (7) A and at least one of B, and (8) A and B.

The expression “based on” used herein is used to describe one or more factors that influence a decision, an action of judgment or an operation described in a phrase or sentence including the relevant expression, and this expression does not exclude additional factors influencing the decision, the action of judgment or the operation.

When a certain component (e.g., a first component) is described as “coupled to” or “connected to” another component (e.g., a second component), this may mean that the certain component may be coupled or connected directly to the other component or that the certain component may be coupled or connected to the other component via a new intervening component (e.g., a third component).

As used herein, the expression “configured to” may have the same meaning as “set to,” “having a capability of,” “changed to,” “manufactured to,” “capable of,” or the like according to context. The expression is not limited to the meaning “specially designed in a hardware manner.” For example, “a processor configured to perform a specific operation” may mean a generic-purpose processor that can perform the specific operation by executing software.

Hereinafter, various embodiments of the present disclosure will be described with reference to the accompanying drawings. In the accompanying drawings and description thereof, like or substantially equivalent components are indicated by like reference numerals. In the following description of the embodiments, repeated descriptions of the identical or relevant components will be omitted. However, even if a description of a component is omitted, such a component is not intended to be excluded in the embodiment.

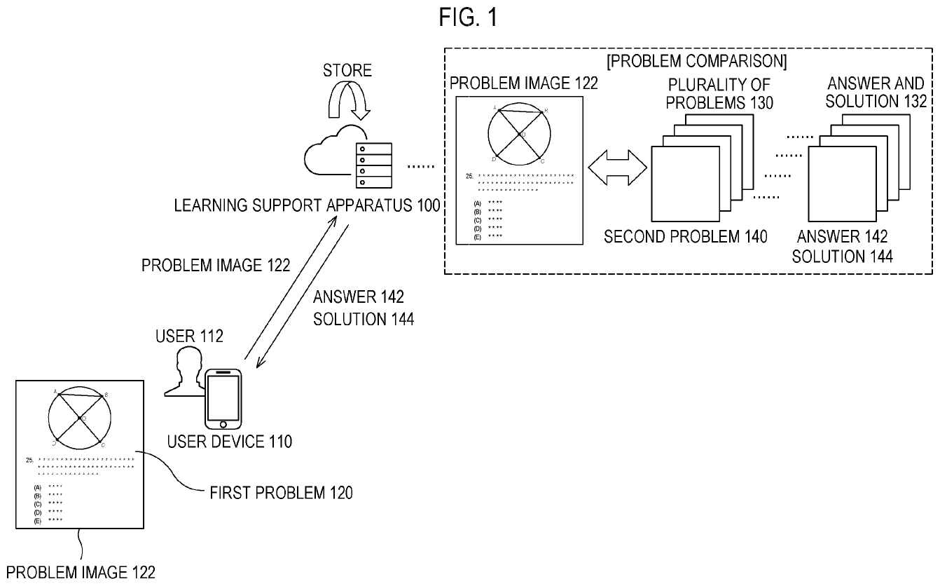

FIG. 1 is a diagram illustrating an operation process of a learning support apparatus 100 according to an embodiment of the present disclosure. When a user photographs and transmits an image of a target problem to be queried to the learning support apparatus 100, the learning support apparatus 100 according to various embodiments of the present disclosure may search a database for a problem corresponding to the target problem and transmit information indicating an answer and/or solution, which has been stored and is responsive to the searched problem, to the user.

Specifically, a user (e.g., a student) 112 may want to know an answer or solution to a specific problem (hereinafter “first problem 120”) during study. The user 112 may transmit an image obtained by photographing the first problem 120 (hereinafter “problem image 122”) to the learning support apparatus 100 through a user device 110. The problem image 122 may be captured by the user device 110 or may be captured by another device and then transmitted to the user device 110. In an embodiment, the user 112 may manually input the first problem 120 to the user device 110 (e.g., text input). In this case, the input information may replace the problem image 122. The present disclosure will be described below with the assumption that the captured problem image 122 is used.

The learning support apparatus 100 may receive the problem image 122 from the user device 110. The learning support apparatus 100 may have a problem database. The problem database may include information on a plurality of problems 130 and answers and/or solutions 132 corresponding to the problems. The problem database may store problems and answers and/or solutions corresponding to the problems in association with each other.

The learning support apparatus 100 may search the problem database for a problem corresponding to the first problem 120 using the problem image 122. This may be performed by comparing information of the problem image 122 with information that the plurality of problems 130 in the problem database have. Specifically, the learning support apparatus 100 may extract one or more layouts from the problem image 122. Each layout may include an area of the problem image 122 in which each piece of information of the first problem 120 is located. In an embodiment, the learning support apparatus 100 may separately extract a layout including an area of the problem image 122 in which textual information of the first problem 120 is located (hereinafter “first layout”) and a layout including an area of the problem image 122 in which illustrative information of the first problem 120 is located (hereinafter “second layout). In the present disclosure, textual information may be information of a problem in a text form such as text and a mathematical expression. Illustrative information may be information of a problem in an image form, such as a drawing, a picture, a table, and a graph. In the above-described first problem 120, textual information may include text or a mathematical expression of the first problem 120. Also, illustrative information of the first problem 120 may include a drawing, a picture, a table, or a graph of the first problem 120.

The learning support apparatus 100 may determine a similarity by comparing the first layout with each piece of textual information of the plurality of problems 130. For example, the learning support apparatus 100 may select one of the plurality of problems 130 (hereinafter “second problem 140”). The learning support apparatus 100 may determine a similarity between the first layout and textual information of the second problem 140 (hereinafter “first similarity”) by comparing the first layout with the textual information of the second problem 140.

Also, the learning support apparatus 100 may determine a similarity by comparing the second layout with each piece of illustrative information of the plurality of problems 130. For example, the learning support apparatus 100 may determine a similarity between the second layout and illustrative information of the second problem 140 (hereinafter “second similarity”) by comparing the second layout with the illustrative information of the second problem 140.

The learning support apparatus 100 may determine a similarity indicating the degree of similarity between the first problem 120 and the second problem 140 (hereinafter “third similarity”) by combining the determined first and second similarities. The learning support apparatus 100 may determine whether the second problem 140 is a problem corresponding to the first problem 120 requested by the user 112 based on whether the third similarity is larger than or equal to a predetermined reference similarity. In other words, when the third similarity is larger than or equal to the predetermined reference similarity, the learning support apparatus 100 may determine that the second problem 140 is a problem identical or similar to the first problem 120 requested by the user 112 through the problem image 122. Meanwhile, when the third similarity is less than the predetermined reference similarity, the learning support apparatus 100 may determine that the second problem 140 is a problem that is different from the first problem 120. The learning support apparatus 100 may determine a similarity between the first problem 120 and each of the plurality of problems 130 by performing such a problem comparison process on each of the plurality of problems 130. In an embodiment, the reference similarity may be set to an appropriate value by an operator of the learning support apparatus 100.

When it is determined that the second problem 140 corresponds to the first problem 120 requested by the user 112, the learning support apparatus 100 may transmit information indicating an answer 142 and/or a solution 144, which is stored in association with the second problem 140 in the problem database, to the user device 110. In an embodiment, when it is determined that there is no problem corresponding to the first problem 120 requested by the user 112 among the plurality of problems 130 as a result of determining a similarity by comparing the first problem 120 with each of the plurality of problems 130 in the problem database, the learning support apparatus 100 may store the problem image 122 of the first problem 120 in the problem database. In an embodiment, when one or more problems having a third similarity greater than or equal to the reference similarity are found, the learning support apparatus 100 may select a certain number (e.g., five) of problems having high similarities among the problems that have been found and transmit the selected problems to the user device 110. Among the selected problems, the user 112 may select a problem and the user device 110 may transmit information on the selected problem to the learning support apparatus 100. The learning support apparatus 100 may transmit an answer and/or solution to the problem selected by the user 112 to the user device 110.

In the present disclosure, the learning support apparatus 100 may be a server which provides a learning support technology according to the present disclosure. However, the learning support apparatus 100 according to the present disclosure may be implemented as various apparatuses and is not limited to a server. The learning support apparatus 100 may communicate with the user device 110 through a program (e.g., an application) installed on the user device 110. Also, the learning support apparatus 100 may provide a webpage for providing the learning support technology according to the present disclosure.

In the present disclosure, a device used by a user, that is, the user device 110, may be any type of device. For example, the user device 110 may be a portable communication device (e.g., a smartphone), a computer device (e.g., a tablet personal computer (PC) or a laptop), a portable multimedia device, a wearable device, or one or more combinations of the aforementioned devices. A program (e.g., an application) for providing the learning support technology according to the present disclosure may be installed on the user device 110. Alternatively, the user device 110 may access a webpage for providing the learning support technology according to the present disclosure and communicate with the learning support apparatus 100.

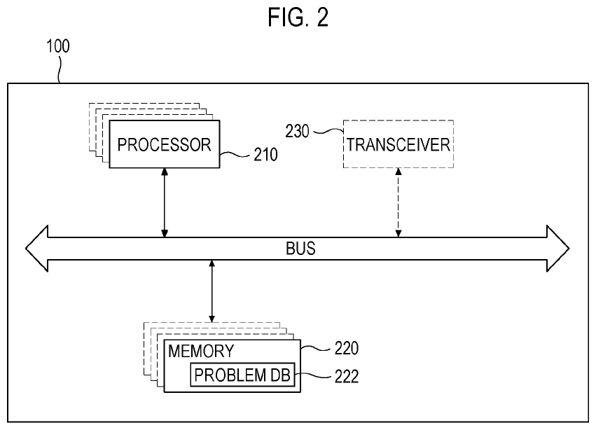

FIG. 2 is a block diagram of the learning support apparatus 100 according to various embodiments of the present disclosure. In an embodiment, the learning support apparatus 100 may include a transceiver 230, one or more processors 210, and/or one or more memories 220. In an embodiment, at least one component of the learning support apparatus 100 may be omitted, or another component may be added to the learning support apparatus 100. In an embodiment, additionally or alternatively, some components may be integrated or implemented as a single entity or a plurality of entities. In the present disclosure, the one or more processors 210 may be referred to as the “processor 210.” The expression “processor 210” may denote a set of one or more processors unless the context clearly indicates otherwise. In the present disclosure, the one or more memories 220 may be referred to as the “memory 220.” The expression “memory 220” may denote a set of one or more memories unless the context clearly indicates otherwise. In an embodiment, at least some of components inside and outside the learning support apparatus 100 may be connected through a bus, a general purpose input/output (GPIO), a serial peripheral interface (SPI), a mobile industry processor interface (MIPI), or the like and transmit and receive data and/or signals.

The processor 210 may control at least one component of the learning support apparatus 100 connected to the processor 210 by executing software (e.g., a command or a program). Also, the processor 210 may perform various operations, such as computation, data generation, and processing, related to the present disclosure. Further, the processor 210 may load data or the like from the memory 220 or store data or the like in the memory 220. In an embodiment, the processor 210 may extract a first layout and/or a second layout from the problem image 122, determine a first similarity between the first layout and textual information of the second problem 140, determine a second similarity between the second layout and illustrative information of the second problem 140, determine a third similarity by combining the first similarity and the second similarity, determine whether the second problem 140 corresponds to the first problem 120, and control the transceiver 230 to transmit information indicating the answer 142 and/or the solution 144 corresponding to the second problem 140 to the user device 110 upon determining that the second problem 140 corresponds to the first problem 120.

The memory 220 may store various pieces of data. Data stored in the memory 220 is acquired, processed, or used by at least one component of the learning support apparatus 100 and may include software (e.g., commands and programs). The memory 220 may include a volatile and/or non-volatile memory. In the present disclosure, commands and programs are software stored in the memory and may include an operating system for controlling resources of the learning support apparatus 100, applications, middleware which provides various functions so that an application may use resources of the learning support apparatus 100, and/or the like. In an embodiment, the memory 220 may store commands which cause the processor 210 to perform operations when executed by the processor 210.

In an embodiment, the memory 220 may include a problem database 222 as the above-described problem database. In other words, the problem database 222 may be a logical database implemented in the one or more memories 220 and having data stored in the one or more memories 220. In an embodiment, the problem database 222 may be a database separately implemented outside the learning support apparatus 100 rather than in the memory 220 in the learning support apparatus 100. In this case, the problem database 222 is a type of server and may communicate with the learning support apparatus 100 through the transceiver 230 and the like.

In an embodiment, the learning support apparatus 100 may further include the transceiver 230 (a communication interface). The transceiver 230 may perform wireless or wired communication between the learning support apparatus 100 and the user device 110 or between the learning support apparatus 100 and another device or server. For example, the transceiver 230 may perform wireless communication according to a protocol, such as enhanced mobile broadband (eMBB), ultra-reliable low-latency communications (URLLC), massive machine type communications (MMTC), long-term evolution (LTE), LTE advanced (LTE-A), new radio (NR), universal mobile telecommunications system (UMTS), global system for mobile communications (GSM), code division multiple access (CDMA), wideband CDMA (WCDMA), wireless broadband (WiBro), wireless fidelity (WiFi), Bluetooth, near field communication (NFC), global positioning system (GPS), or global navigation satellite system (GNSS). For example, the transceiver 230 may perform wired communication according to a protocol such as universal serial bus (USB), recommended standard-232 (RS-232), or plain old telephone service (POTS).

In an embodiment, the learning support apparatus 100 may not include the transceiver 230. In this case, the problem image 122 may be transmitted to the learning support apparatus 100 in various ways, and the learning support apparatus 100 may process the problem image 122 and determine a third similarity between the first problem 120 and the second problem 140 as described above.

Various embodiments of the learning support apparatus 100 according to the present disclosure may be combined with each other. The embodiments may be combined according to the number of cases, and the combined embodiments of the learning support apparatus 100 also fall within the scope of the present disclosure. The above-described internal/external components of the learning support apparatus 100 according to the present disclosure may be added, altered, replaced, or removed according to embodiments. Also, the above-described internal/external components of the learning support apparatus 100 may be implemented as hardware components.

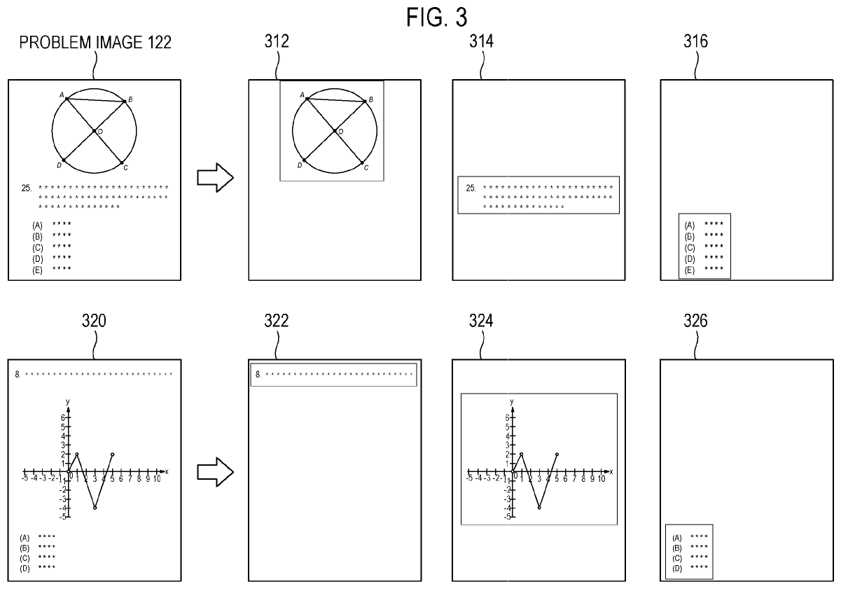

FIG. 3 is a set of diagrams illustrating a process of extracting one or more layouts from the problem image 122 according to an embodiment of the present disclosure. As described above, the learning support apparatus 100 may extract one or more layouts having each piece of information of the first problem 120 from the problem image 122. Although examples of mathematical problems are described below, the problems in the present disclosure are not limited to mathematical problems.

In an example, the processor 210 of the learning support apparatus 100 may extract one or more layouts 312, 314, and 316 from the problem image 122. Each layout may include an area of a problem image in which each piece of information of a corresponding problem is located. The layout 312 may be a layout including illustrative information of the corresponding problem, that is, a drawing (a geometrical figure). The layout 314 may be a layout including textual information of the corresponding problem, that is, text about what the corresponding problem asks. The layout 316 may be a layout including textual information of the corresponding problem, that is, text (numbers) representing examples of the corresponding problem. In other words, in this example, the layout 314 and the layout 316 may be first layouts, and the layout 312 may be a second layout.

In another example, the processor 210 may extract one or more layouts 322, 324, and 326 from a problem image 320. The layout 322 may be a layout including textual information of a corresponding problem, that is, text and a mathematical expression about what the corresponding problem asks. The layout 324 may be a layout including illustrative information of the corresponding problem, that is, a graph. The layout 326 may be a layout including textual information of the corresponding problem, that is, text (numbers) representing examples of the corresponding problem. In other words, in this example, the layout 322 and the layout 326 may be first layouts, and the layout 324 may be a second layout.

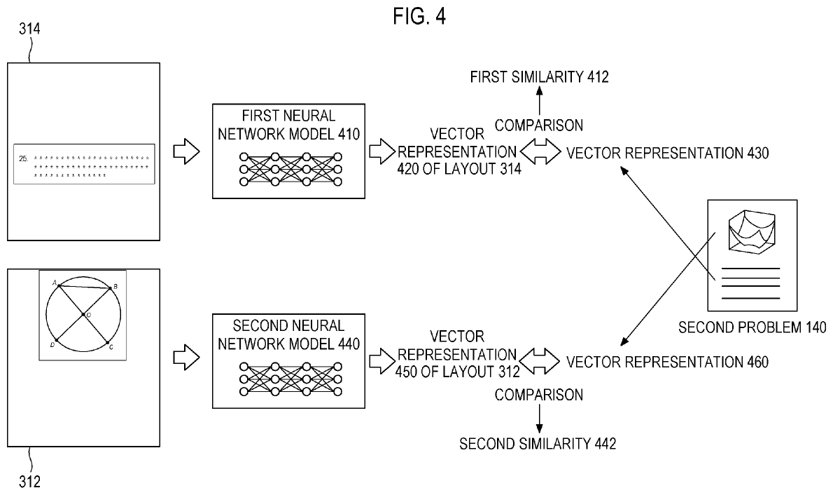

FIG. 4 is a diagram illustrating a process of determining a similarity between problems through image vectorization according to an embodiment of the present disclosure. In an embodiment, the learning support apparatus 100 may compare each layout with previously stored information of the second problem 140 using a trained neural network model and determine a similarity.

Specifically, the memory 220 of the learning support apparatus 100 may store a first neural network model 410. The first neural network model 410 may have been trained to derive a vector representation of an image having textual information (text, a mathematical expression, etc.) from the image. In other words, the first neural network model 410 may convert an image having textual information into a vector representation of the image. In the present disclosure, the vector conversion of an image may denote the conversion of the image into an n-dimensional vector. This vector may have a numerical feature corresponding to the image. Because many algorithms used in machine learning require quantified data to extract and analyze a feature, image vectorization may be performed to utilize machine learning. For example, pixels of the image, the frequency of appearance of a term in text, or the like may be quantified and represented as a vector. In the present disclosure, a neural network model may be designed to implement the structure of human brains in a computer and may include a plurality of network nodes which simulate neurons of a human neural network and have weights. The plurality of network nodes may have connection with each other by simulating neural synaptic activity in which neurons exchange signals through synapses. In the neural network model, the plurality of network nodes may be located in layers of different depths and exchange data according to convolutional connection. The neural network model may be, for example, an artificial neural network, a convolutional neural network, or the like. The neural network model may be trained through machine learning. By means of machine learning, the neural network model may extract features of objects, such as lines of a certain image, from the image, analyze the features, and derive a correlation between the features. The neural network model may also represent the image as a vector based on the correlation.

The processor 210 may input a first layout (e.g., the layout 314) to the first neural network model 410. Accordingly, the first neural network model 410 may output a vector representation 420 of the first layout. Meanwhile, the memory 220 may store a vector representation of an image representing textual information of the second problem 140 in advance. The processor 210 may compare the vector representation 420 of the first layout with the previously stored vector representation of the textual information of the second problem 140. Through the comparison process, the processor 210 may determine a similarity between textual information of the first problem 120 and the textual information of the second problem 140 (hereinafter “first similarity 412”).

In an embodiment, a comparison between vector representations may be performed by calculating a difference between values of the vector representations. For example, when a difference between values of two vector representations is closer to 0, two images corresponding to the two vector representations may be determined to be similar to each other. In an embodiment, a value inversely proportional to the difference between the two vector representation values may be determined as the first similarity 412.

In an embodiment, the vector representation of the textual information of the second problem 140 may be previously stored in the memory 220 in advance, or acquired by inputting an image having the textual information to the first neural network model 410.

Meanwhile, the memory 220 may store a second neural network model 440. The second neural network model 440 may have been trained to derive a vector representation of an image having illustrative information (a drawing, a picture, etc.) from the image. In other words, the second neural network model 440 may convert an image having illustrative information into a vector representation of the image.

The processor 210 may input a second layout (e.g., the layout 312) to the second neural network model 440. Accordingly, the second neural network model 440 may output a vector representation 450 of the second layout. The memory 220 may store a vector representation of an image representing illustrative information of the second problem 140 in advance. The processor 210 may compare the vector representation 450 of the second layout with the previously stored vector representation of the illustrative information of the second problem 140. Through the comparison process, the processor 210 may determine a similarity between illustrative information of the first problem 120 and the illustrative information of the second problem 140 (hereinafter “second similarity 442”). In an embodiment, the vector representation of the illustrative information of the second problem 140 may be stored in the memory 220 in advance or acquired by inputting an image having the illustrative information to the second neural network model 440.

In an embodiment, the first neural network model 410 and/or the second neural network model 440 may be stored in a server separately provided outside the learning support apparatus 100. In this case, the processor 210 may communicate with the server by controlling the transceiver 230, thereby inputting information to the first neural network model 410 and/or the second neural network model 440 and acquiring information output from the first neural network model 410 and/or the second neural network model 440.

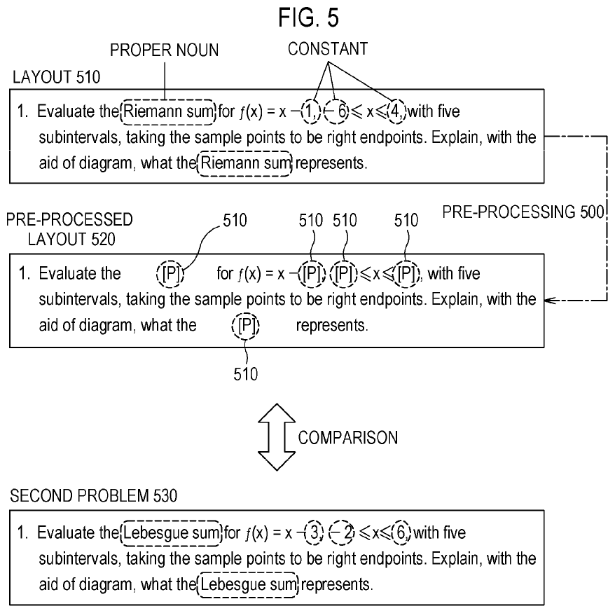

FIG. 5 is a diagram illustrating a process of improving a search for a problem by templatizing a target problem according to an embodiment of the present disclosure. In an embodiment, the learning support apparatus 100 may pre-process generalizable pieces of textual information of the first problem 120 in the problem image 122 and then perform a search for a problem, thereby finding the second problem 140 corresponding to the first problem 120 accurately and quickly.

Specifically, the processor 210 may pre-process a first layout of the first problem 120 before inputting the first layout to the first neural network model 410 (500). A layout 510 is shown as an example of the first layout of the first problem 120. The layout 510 may have textual information (text and a mathematical expression) of the first problem 120. Among the pieces of textual information, “Riemann sum” may be a proper noun indicating the mathematical concept of a Riemann sum. Also, among the pieces of textual information, “1,” “−6,” and “4” may be constants. Proper nouns and constants may be generalizable portions of the text and mathematical expression.

The processor 210 may identify proper nouns (e.g., “Riemann sum”) and/or constants (e.g., “1,” “−6,” and “4”) in the textual information of the layout 510. The processor 210 may pre-process the first layout by replacing portions corresponding to the identified proper nouns and/or constants with a placeholder [P] (500). The placeholder [P] generalizes the location in which the generalizable portions are located so that various pieces of information may be applied to the location. In an embodiment, the processor 210 may simply change portions corresponding to proper nouns and/or constants to blanks by deleting the proper nouns and/or constants.

When the layout 510 is pre-processed as described above, the processor 210 may determine a similarity by comparing a pre-processed layout 520 with the plurality of problems 130 in the problem database. This process may be performed in the same manner as the process of determining a similarity (e.g., the first similarity 412) by comparing a first layout with a problem in the problem database (e.g., the second problem 140). In other words, the processor 210 may input the pre-processed layout 520 to the first neural network model 410. In this case, the portions which have been replaced with the placeholder [P] for generalization do not affect similarity calculations, and thus a problem corresponding to the first problem 120 may be searched more accurately.

For example, a problem 530 which is stored in the memory 220 in advance may have textual information similar to the textual information of the layout 510. However, the problem 530 may require a Lebesgue sum instead of a Riemann sum, and constants of the mathematical expression may be “3,” “−2,” and “6” instead of “1,” “−6,” and “4.” In other words, the problem 530 may have detailed information different from that of the layout 510, but may be the same kind of the problem as the layout 510. When the layout 510 is compared with the problem 530 without pre-processing, there is a difference in the detailed information, and thus the processor 210 may determine that a similarity between the layout 510 and the problem 530 is low. However, when the layout 520 that is pre-processed (500) as described above is compared with the problem 530, the processor 210 may determine that a similarity between the layout 520 and the problem 530 is relatively high because proper nouns and constants have been replaced with the placeholder [P]. In this manner, when the pre-processing is performed (500), it is possible to prevent a case in which the learning support apparatus 100 determines two problems of the same kind to be different because pieces of detailed information (proper nouns, constants, etc.) of the two problems differ from each other.

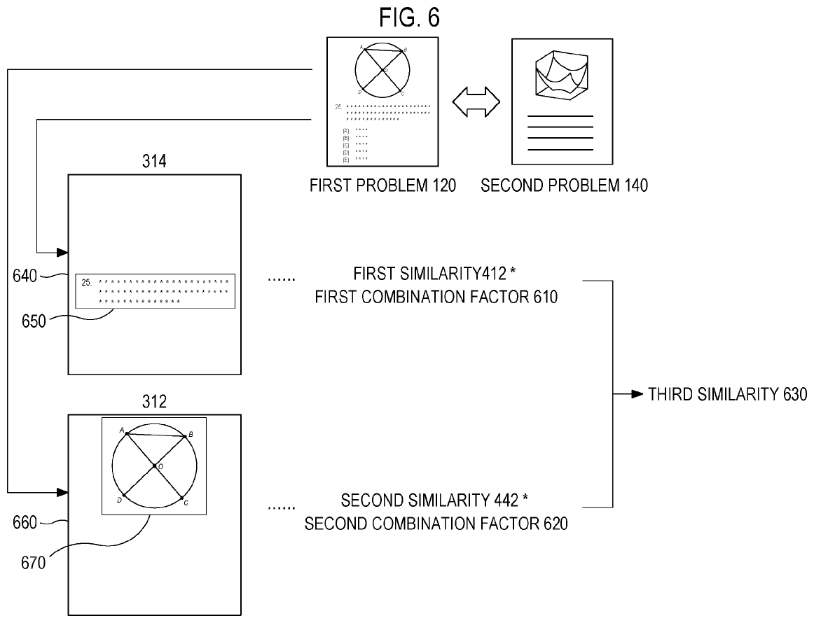

FIG. 6 is a diagram illustrating a process of determining a third similarity 630 between the first problem 120 and the second problem 140 by using the first similarity 412 and the second similarity 442 according to an embodiment of the present disclosure. As described above, the learning support apparatus 100 may determine the third similarity 630 representing how similar the first problem 120 and the second problem 140 are by combining the first similarity 412 of a first layout having textual information and the second similarity 442 of a second layout having illustrative information.

Specifically, the processor 210 may determine combination factors for combining the first similarity 412 and the second similarity 442 according to predetermined criteria. In other words, the processor 210 may determine a first combination factor 610 to be applied to the first similarity 412 and a second combination factor 620 to be applied to the second similarity 442. As described above, the first similarity 412 may denote a similarity between the first layout 314 including an area in which textual information of the first problem 120 is located and an image representing textual information of the second problem 140. The second similarity 442 may denote a similarity between the second layout 312 including an area in which illustrative information of the first problem 120 is located and an image representing illustrative information of the second problem 140.

Subsequently, the processor 210 may apply the first combination factor 610 to the first similarity 412, apply the second combination factor 620 to the second similarity 442, and then determine the third similarity 630 by combining the similarities to which the combination factors are applied. In an embodiment, applying a combination factor to a similarity may be multiplying the similarity by the combination factor. In an embodiment, combining similarities to which combination factors are applied may be summing the similarities to which the combination factors are applied. The determined third similarity 630 represents the degree of similarity between the first problem 120 and the second problem 140, and the processor 210 may determine whether the first problem 120 and the second problem 140 correspond to each other according to whether the third similarity 630 is a predetermined reference similarity or more.

The predetermined criteria for determining the above-described combination factors may be set in various ways. In an embodiment, the predetermined criteria are for setting the first combination factor 610 smaller, when an amount 650 of textual information of the first layout 314 is smaller compared to a size 640 of the first layout 314. In an embodiment, the amount of textual information may be determined based on the number of characters, the number of sentences, the lengths of sentences, whether a mathematical expression is included, and the like. Also, in an embodiment, the predetermined criteria are for setting the first combination factor 610 smaller, when a larger number of problems have a certain similarity or more with the first layout 314 among the plurality of problems 130 in the memory 220.

In an embodiment, the predetermined criteria are for setting the second combination factor 620 smaller, when an amount 670 of illustrative information of the second layout 312 is smaller compared to a size 660 of the second layout 312. In an embodiment, the amount of illustrative information may be determined based on the size of a corresponding drawing, picture, or the like. Also, in an embodiment, the predetermined criteria are for setting the second combination factor 620 smaller, when a larger number of problems have a certain similarity or more with the second layout 312 among the plurality of problems 130 in the memory 220. In an embodiment, the predetermined criteria may include at least one of the above-described criteria.

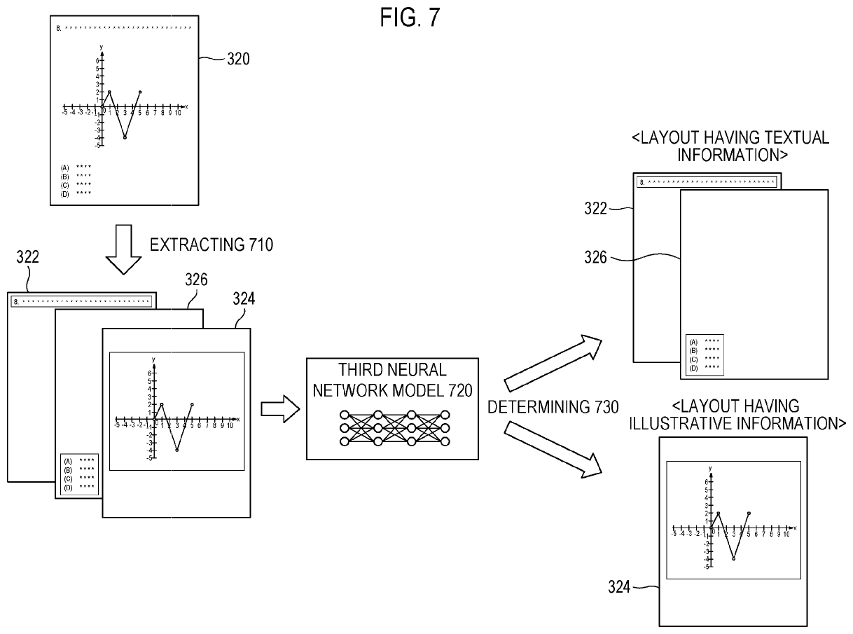

FIG. 7 is a diagram illustrating a process of distinguishing between a layout having textual information and a layout having illustrative information according to an embodiment of the present disclosure. As described above, the learning support apparatus 100 may extract a first layout including an area in which textual information is located and/or a second layout including an area in which illustrative information is located from a problem image. In an embodiment, the learning support apparatus 100 may distinguish between textual information and illustrative information using a neural network model.

Specifically, the processor 210 may separately extract one or more layouts 322, 324, and 326 including an area of the problem image 320 in which each piece of information of a corresponding problem is located from the problem image 320 (710). The processor 210 may input each of the one or more layouts 322, 324, and 326 to a third neural network model 720. The third neural network model 720 may have been trained through machine learning to distinguish whether certain information is textual information or illustrative information. In other words, the third neural network model 720 may determine whether an image object in an input image is a mathematical expression, drawing, picture, table, or graph. The description of a neural network model has been provided above.

The processor 210 may classify each layout using information output from the third neural network model 720 as the one or more layouts 322, 324, and 326 are input to the third neural network model 720. In other words, the processor 210 may determine whether each layout is a layout having textual information (i.e., a first layout) or a layout having illustrative information (i.e., a second layout) (730).

In an embodiment, the third neural network model 720 may be stored in a server separately provided outside the learning support apparatus 100. In this case, the processor 210 may communicate with the server by controlling the transceiver 230, thereby inputting information to the third neural network model 720 and acquiring information output from the third neural network model 720.

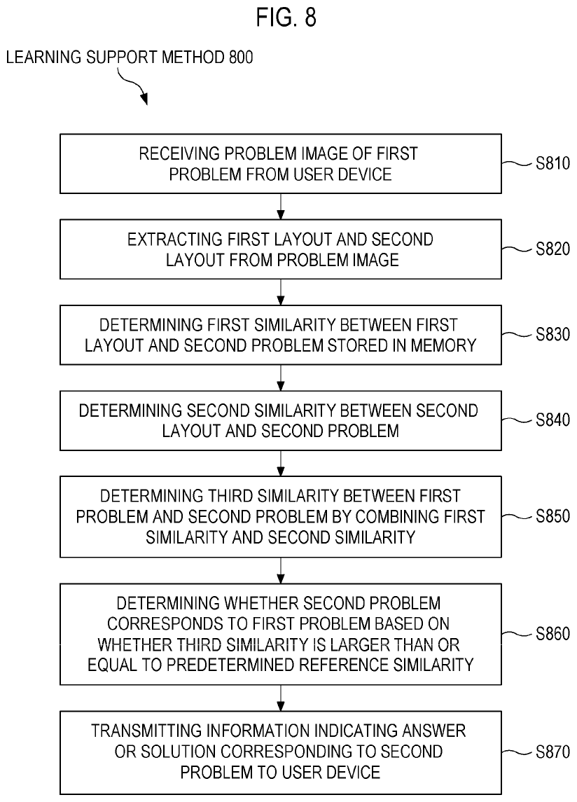

FIG. 8 is a flowchart illustrating a method 800 of supporting learning of a user which may be performed by the learning support apparatus 100 according to an embodiment of the present disclosure. The learning support method 800 according to the embodiment of the present disclosure may be a method implemented by a computer. In the flowchart shown in the drawing, operations of a method or algorithm according to the present disclosure are described in sequence. However, the operations may be performed not only in sequence but also in any order according to the present disclosure. Descriptions of the flowchart do not exclude alterations or modifications of the method or algorithm and do not mean that any operation is essential or preferable. In an embodiment, at least some operations may be performed in parallel, repeatedly, or heuristically. In an embodiment, at least some operations may be omitted, or another operation may be added.

In supporting learning of the user 112, an electronic apparatus (e.g., the learning support apparatus 100) according to the present disclosure may perform the learning support method 800 according to various embodiments of the present disclosure. The learning support method 800 according to an embodiment of the present disclosure may include receiving the problem image 122 of the first problem 120 from the user device 110 (S810), extracting a first layout and a second layout from the problem image 122 (S820), determining the first similarity 412 between the first layout and the second problem 140 stored in the memory 220 (S830), determining the second similarity 442 between the second layout and the second problem 140 (S840), determining the third similarity 630 between the first problem 120 and the second problem 140 by combining the first similarity 412 and the second similarity 442 (S850), determining whether the second problem 140 corresponds to the first problem 120 based on whether the third similarity 630 is larger than or equal to a predetermined reference similarity (S860), and/or transmitting information indicating the answer 142 or the solution 144 corresponding to the second problem 140 to the user device 110 (S870).

In S810, the transceiver 230 of the apparatus 100 may receive the problem image 122 obtained by photographing the first problem 120 from the user device 110 of the user 112. In S820, the processor 210 of the apparatus 100 may extract a first layout including an area of the problem image 122 in which textual information of the first problem 120 is located and a second layout including an area of the problem image 122 in which illustrative information of the first problem 120 is located.

In S830, the processor 210 may determine the first similarity 412 between the first layout and the textual information of the second problem 140 stored in the memory 220. In S840, the processor 210 may determine the second similarity 442 between the second layout and the illustrative information of the second problem 140.

In S850, the processor 210 may determine the third similarity 630 between the first problem 120 and the second problem 140 by combining the first similarity 412 and the second similarity 442. In S860, the processor 210 may determine whether the second problem 140 corresponds to the first problem 120 based on whether the third similarity 630 is larger than or equal to a predetermined reference similarity. In S870, the processor 210 may control the transceiver 230 to transmit information indicating the answer 142 and/or the solution 144 corresponding to the second problem 140 to the user device 110 upon determining that the second problem 140 corresponds to the first problem 120.

In an embodiment, determining the first similarity 412 (S830) may include inputting the first layout to the first neural network model 410, obtaining a vector representation of the first layout from the first neural network model 410, and determining the first similarity 412 by comparing the output vector representation of the first layout with a vector representation of the textual information of the second problem 140.

In an embodiment, determining the first similarity 412 (S830) may further include pre-processing the first layout by replacing a proper noun and/or a constant of the textual information of the first layout with placeholders [P] before inputting the first layout to the first neural network model 410.

In an embodiment, determining the second similarity 442 (S840) may include inputting the second layout to the second neural network model 440, obtaining a vector representation of the second layout from the second neural network model 440, and determining the second similarity 442 by comparing the output vector representation of the second layout with a vector representation of the illustrative information of the second problem 140.

In an embodiment, determining the third similarity 630 (S850) may include determining the first combination factor 610 and/or the second combination factor 620 based on predetermined criteria, and determining the third similarity 630 by combining the first similarity 412 to which the first combination factor 610 is applied and the second similarity 442 to which the second combination factor 620 is applied.

In an embodiment, the predetermined criteria may be that as an amount of the textual information of the first layout compared to a size of the first layout or the number of problems stored in the memory 220 having a certain similarity or more with the first layout decreases, the first combination factor 610 decreases. Also, in an embodiment, the predetermined criteria may be that as an amount of the illustrative information of the second layout compared to a size of the second layout or the number of problems stored in the memory 220 having a certain similarity or more with the second layout decreases, the second combination factor 620 decreases.

In an embodiment, extracting the first layout and the second layout (S820) may include extracting, from the problem image 122, an area of the problem image 122 in which each piece of information of the first problem 120 is located as one or more layouts, and determining each of the one or more layouts as the first layout or the second layout by inputting the one or more layouts to the third neural network model 720.

In an embodiment, the learning support method 800 may further include storing, by the processor 210, the problem image 122 of the first problem 120 in the memory 220 upon determining that no problem corresponds to the first problem 120 among the plurality of problems 130.

According to various embodiments of the present disclosure, it is possible to simply provide a solution to a problem to a user so that learning of the user can be effectively supported.

According to various embodiments of the present disclosure, it is possible to accurately find a problem corresponding to a target problem that a user queries by further considering illustrative information (a drawing, a graph, a picture, etc.) of the problem.

According to various embodiments of the present disclosure, optical character recognition (OCR) is not simply performed on text and a mathematical expression of a problem, but rather image vectorization is performed to search for a corresponding problem. Consequently, it is possible to reduce the influence of text fonts or mathematical symbols on the search.

According to various embodiments of the present disclosure, at least one layout including each piece of information of a problem is extracted from the problem, and image vectorization is performed on each layout to search a database for a corresponding problem. Consequently, it is possible to rapidly carry out the search compared to the case of searching with respect to the whole problem.

Various embodiments of the present disclosure can be implemented as software recorded in a machine-readable recording medium. The software may be intended to implement the various embodiments of the above-described present disclosure. The software can be inferred from the various embodiments of the present disclosure by programmers of a technical field to which the present disclosure pertains. For example, the software may be a command (e.g., code or code segments) or a program which can be read by a machine. The machine is a device which can operate according to a command called from the recording medium and may be a computer by way of example. In an embodiment, the machine may be the learning support apparatus 100 according to the embodiments of the present disclosure. In an embodiment, a processor of the machine may execute a called command and cause components of the machine to perform functions corresponding to the command. In an embodiment, the processor may be the one or more processors 210 according to the embodiments of the present disclosure. The recording medium may be any kind of machine-readable recording medium in which data is stored. Examples of the recording medium includes a read-only memory (ROM), a random access memory (RAM), a compact disc-ROM (CD-ROM), a magnetic tape, a floppy disk, an optical data storage device, and the like. In an embodiment, the recording medium may be the one or more memories 220. In an embodiment, the recoding medium may be implemented by computer systems and the like which are connected through a network in a distributed manner. The software may be distributed to computer systems and stored and executed therein. The recording medium may be a non-transitory recording medium. The non-transitory recording medium means a tangible medium regardless of whether data is stored semi-permanently or temporarily and does not include a signal which is transitory.

Although the present disclosure have been described above with reference to the various embodiments, the present disclosure encompasses various substitutions, modifications, and alterations which can be made within the scope understood by those of ordinary skill in the technical field to which the present disclosure pertains. Also, it should be understood that the accompanying claims encompass such substitutions, modifications, and alterations.

What is claimed is:

1. An apparatus comprising:
a transceiver configured to receive a problem image of a first problem from an user device;
one or more processors; and
one or more memories configured to store commands that cause the one or more processors to perform an operation when the commands are executed by the one or more processors, and information related to a plurality of problems,
wherein the one or more processors are configured to:
extract, from the problem image, a first layout including an area of the problem image in which textual information of the first problem is located and a second layout including an area of the problem image in which illustrative information of the first problem is located;
determine a first similarity between the first layout and textual information of a second problem stored in the one or more memories;
determine a second similarity between the second layout and illustrative information of the second problem;
determine a third similarity between the first problem and the second problem by combining the first similarity and the second similarity;
determine whether the second problem corresponds to the first problem based on whether the third similarity is larger than or equal to a predetermined reference similarity; and
upon determining that the second problem corresponds to the first problem, control the transceiver to transmit information indicating an answer or solution corresponding to the second problem to the user device.

2. The apparatus of claim 1, wherein the one or more processors are further configured to:
input the first layout to a first neural network model that is trained to derive a first vector representation from an image having textual information;
obtain the first vector representation of the first layout from the first neural network model; and
determine the first similarity by comparing the first vector representation of the first layout with a previously stored vector representation of the textual information of the second problem.

3. The apparatus of claim 2, wherein the one or more processors are further configured to:
pre-process the first layout by replacing a proper noun or a constant of the textual information of the first layout with a placeholder, before inputting the first layout to the first neural network model.

4. The apparatus of claim 2, wherein the one or more processors are further configured to:
input the second layout to a second neural network model that is trained to derive a second vector representation from an image having illustrative information;
obtain the second vector representation of the second layout from the second neural network model; and
determine the second similarity by comparing the second vector representation of the second layout with a previously stored vector representation of the illustrative information of the second problem.

5. The apparatus of claim 1, wherein the one or more processors are further configured to:
determine a first combination factor to be applied to the first similarity and a second combination factor to be applied to the second similarity based on predetermined criteria; and
determine the third similarity by combining the first similarity to which the first combination factor is applied and the second similarity to which the second combination factor is applied.

6. The apparatus of claim 5, wherein the predetermined criteria are that:
as an amount of the textual information of the first layout compared to a size of the first layout decreases, the first combination factor decreases,
as the number of problems having a certain similarity or more with the first layout stored in the one or more memories decreases, the first combination factor decreases,
as an amount of the illustrative information of the second layout compared to a size of the second layout decreases, the second combination factor decreases, and
as the number of problems having a certain similarity or more with the second layout stored in the one or more memories decreases, the second combination factor decreases.

7. The apparatus of claim 4, wherein the one or more processors are further configured to:
extract, from the problem image, an area of the problem image in which each piece of information of the first problem is located as one or more layouts; and
determine each of the one or more layouts as the first layout or the second layout by inputting the one or more layouts to a third neural network model that is trained to distinguish between textual information and illustrative information.

8. The apparatus of claim 7, wherein at least one of the first neural network model, the second neural network model, and the third neural network model is stored in a server, and
wherein the one or more processors control the transceiver to communicate with the server.

9. The apparatus of claim 1, wherein the one or more processors are further configured to:
store the problem image of the first problem in the one or more memories upon determining that no problem corresponds to the first problem among the plurality of problems.

10. The apparatus of claim 1, wherein the textual information of the first problem includes text or a mathematical expression of the first problem, and
wherein the illustrative information of the first problem includes a drawing, a picture, a table, or a graph of the first problem.

11. A method performed by an apparatus including a transceiver communicating with a user device, one or more processors, and one or more memories storing commands that cause the one or more processors to perform an operation when the commands are executed by the one or more processors, and information related to a plurality of problems, the method comprising:
receiving, by the transceiver, a problem image of a first problem from the user device;
extracting, from the problem image by the one or more processors, a first layout including an area of the problem image in which textual information of the first problem is located and a second layout including an area of the problem image in which illustrative information of the first problem is located;
determining, by the one or more processors, a first similarity between the first layout and textual information of a second problem stored in the one or more memories;
determining, by the one or more processors, a second similarity between the second layout and illustrative information of the second problem;
determining, by the one or more processors, a third similarity between the first problem and the second problem by combining the first similarity and the second similarity;
determining, by the one or more processors, whether the second problem corresponds to the first problem based on whether the third similarity is larger than or equal to a predetermined reference similarity; and
upon determining that the second problem corresponds to the first problem, transmitting, by the transceiver, information indicating an answer or solution corresponding to the second problem to the user device.

12. The method of claim 11, wherein determining the first similarity includes:
inputting the first layout to a first neural network model that is trained to derive a first vector representation from an image having textual information;
obtaining the first vector representation of the first layout from the first neural network model; and
determining the first similarity by comparing the first vector representation of the first layout with a previously stored vector representation of the textual information of the second problem.

13. The method of claim 12, wherein determining the first similarity includes,
pre-processing the first layout by replacing a proper noun or a constant of the textual information of the first layout with a placeholder, before inputting the first layout to the first neural network model.

14. The method of claim 12, wherein determining the second similarity includes:
inputting the second layout to a second neural network model that is trained to derive a second vector representation from an image having illustrative information;
obtaining the second vector representation of the second layout from the second neural network model; and
determining the second similarity by comparing the second vector representation of the second layout with a previously stored vector representation of the illustrative information of the second problem.

15. The method of claim 11, wherein determining the third similarity includes:
determining a first combination factor to be applied to the first similarity and a second combination factor to be applied to the second similarity based on predetermined criteria; and
determining the third similarity by combining the first similarity to which the first combination factor is applied and the second similarity to which the second combination factor is applied.

16. The method of claim 15, wherein the predetermined criteria are that:
as an amount of the textual information of the first layout compared to a size of the first layout decreases, the first combination factor decreases,
as the number of problems having a certain similarity or more with the first layout stored in the one or more memories decreases, the first combination factor decreases,
as an amount of the illustrative information of the second layout compared to a size of the second layout decreases, the second combination factor decreases, and
as the number of problems having a certain similarity or more with the second layout stored in the one or more memories decreases, the second combination factor decreases.

17. The method of claim 14, wherein extracting the first layout and the second layout includes:
extracting, from the problem image, an area of the problem image in which each piece of information of the first problem is located as one or more layouts; and
determining each of the one or more layouts as the first layout or the second layout by inputting the one or more layouts to a third neural network model that is trained to distinguish between textual information and illustrative information.

18. The method of claim 11, wherein the method further comprises:
storing, by the one or more processors, the problem image of the first problem in the one or more memories upon determining that no problem corresponds to the first problem among the plurality of problems.

19. The method of claim 11, wherein the textual information of the first problem includes text or a mathematical expression of the first problem, and
wherein the illustrative information of the first problem includes a drawing, a picture, a table or a graph of the first problem.

20. A non-transitory computer-readable recording medium storing commands that cause one or more processors to perform an operation when the commands are executed by the one or more processors, the commands comprising:
extracting, from a problem image of a first problem, a first layout including an area of the problem image in which textual information of the first problem is located and a second layout including an area of the problem image in which illustrative information of the first problem is located;
determining a first similarity between the first layout and textual information of a second problem stored in one or more memories;
determining a second similarity between the second layout and illustrative information of the second problem;
determining a third similarity between the first problem and the second problem by combining the first similarity and the second similarity;
determining whether the second problem corresponds to the first problem based on whether the third similarity is larger than or equal to a predetermined reference similarity; and
upon determining that the second problem corresponds to the first problem, controlling a transceiver to transmit information indicating an answer or solution corresponding to the second problem to an user device.
